(19) United States
(12) Patent Application Publication
(10) Pub. No.: US 2024/0114368 A1
(43) Pub. Date: Apr. 4, 2024

(54) USING TELEMETRY METRICS FOR REMEDIATING NETWORK ISSUES

(71) Applicant: ARRIS Enterprises LLC, Suwanee, GA (US)

(72) Inventor: Krishna Prasad PANJE, Bengaluru (IN)

(21) Appl. No.: 18/376,544

(22) Filed: Oct. 4, 2023

Related U.S. Application Data
(60) Provisional application No. 63/412,948, filed on Oct. 4, 2022.

(51) Int. Cl. H04W 24/08; H04B 17/318; H04W 24/02; H04W 24/04

(52) U.S. Cl. CPC H04W 24/08; H04B 17/318; H04W 24/02; H04W 24/04

(57) ABSTRACT

As part of telemetry monitoring and collecting, a network resource averages one or more telemetry metrics associated with a network device for each network issue, such as received signal strength indicators (RSSI), channel utilizations, both associated with an installation issue, a usage issue, or both, respectively. The average is compared to a corresponding threshold and based on that comparison one or more configuration notifications are determined. The one or more configuration notifications are sent to a client device associated with a user so as to notify, inform or otherwise instruct the user as to remediating the network issue. The network resource can continuously, periodically, at timed intervals, on-demand, or otherwise monitor and collect the one or more telemetry metrics after an indication that an attempt has been made to remediate the network issue.

### BACKGROUND

Companies are increasingly providing Multiple Access Point (MAP) architecture or Home Network Controller (HNC) and/or mesh type of wireless fidelity (Wi-Fi) management, with multiple access point devices and/or extender access point devices within the network to improve Quality of Experience (QoE) of the user by offering extended coverage with seamless roaming. However, network issues can arise when a network is not configured to optimize network performance. Generally, telemetry data is available but not typically used to provide a user with remediation for certain network issues Thus, there is need to provide for remediating network issues using telemetry metrics.

### SUMMARY

According to aspects of the present disclosure there are provided novel solutions for using telemetry data (such as one or more telemetry metrics) to provide remediation of network issue by sending one or more configuration notifications after analyzing the one or more telemetry metrics. Typically, access point devices (APD can be set up or configured so as to establish a network within a network environment. As an example, a user can install (such as dispose, position or locate) a main APD and a satellite APD (for example, one or more EAPDS). Any of the main APD, one or more satellite APDs, or any combination thereof can be installed at a location at a premises to form a configuration. Once the configuration or mesh network is formed, the main APD and/or the satellite APD are ready to use. However, if a main APD and/or the satellite APD is located such that a client device has difficulty in communicating, a user can experience one or more network issues, for example, low received signal strength indicator (RSSI) and/or channel utilization as indicated by one or more telemetry metrics. One or more novel solutions provide for monitoring one or more telemetry metrics associated with an APD so as to determine one or more network issues and to provide one or more configuration notifications to a client device associated with a user based on the determination so as to provide an improved QoE.

An aspect of the present disclosure provides network resource for monitoring one or more telemetry parameters associated with a network device. The network resource comprises a memory storing one or more computer-readable instructions and a processor configured to execute the one or more computer-readable instructions stored on the memory to cause the network resource to monitor one or more telemetry metrics associated with the network device, compare the one or more telemetry metrics associated with a network issue to a threshold associated with the network issue, and send one or more configuration notifications based on the comparison and the network issue.

In an aspect of the present disclosure, the monitoring comprises receiving the one or more telemetry metrics from the network device.

In an aspect of the present disclosure, the processor is further configured to execute the one or more computer-readable instructions to cause the network resource to select the network issue for monitoring from a plurality of network issues.

In an aspect of the present disclosure, the network issue comprises an installation issue, a usage issue, or both, and wherein the threshold comprises an installation threshold associated with the installation issue, and a usage threshold associated with the usage issue.

In an aspect of the present disclosure, the one or more telemetry metrics comprise one or more received signal strength indicators (RSSIs) associated with the installation issue, one or more channel utilizations associated with the usage issue, or both.

In an aspect of the present disclosure, the comparing the one or more telemetry metrics to the threshold comprises averaging the one or more RSSIs associated with the network device and comparing the averaged RSSIs to the installation threshold, and averaging the one or more channel utilizations associated with the network device and comparing the averaged channel utilization to the usage threshold.

In an aspect of the present disclosure, the one or more configuration notifications comprise one or more remedial actions.

An aspect of the present disclosure provides a method for monitoring one or more telemetry parameters associated with a network device. The method comprises monitoring one or more telemetry metrics associated with the network device, monitoring one or more telemetry metrics associated with the network device, comparing the one or more telemetry metrics associated with a network issue to a threshold associated with the network issue, and sending one or more configuration notifications based on the comparison and the network issue.

In an aspect of the present disclosure, the method is such that the monitoring comprises receiving the one or more telemetry metrics from the network device.

In an aspect of the present disclosure, the method further comprises selecting the network issue for monitoring from a plurality of network issues.

In an aspect of the present disclosure, the method is such that the network issue comprises an installation issue, a usage issue, or both, and wherein the threshold comprises an installation threshold associated with the installation issue, and a usage threshold associated with the usage issue.

In an aspect of the present disclosure, the method is such the one or more telemetry metrics comprise one or more received signal strength indicators (RSSIs) associated with the installation issue, one or more channel utilizations associated with the usage issue, or both.

In an aspect of the present disclosure, the method is such that comparing the one or more telemetry metrics to the threshold comprises averaging the one or more RSSIs associated with the network device and comparing the averaged RSSIs to the installation threshold, and averaging the one or more channel utilizations associated with the network device and comparing the averaged channel utilization to the usage threshold.

In an aspect of the present disclosure, the method is such that the one or more configuration notifications comprise one or more remedial actions.

An aspect of the present disclosure provides a non-transitory computer readable medium a network resource for monitoring one or more telemetry parameters associated with a network device. The program when executed by a processor of the network resource, causes the network resource to perform one or more operations including the steps of the methods described above.

The above-described electronic apparatus(es) and/or network devices may be implemented as any of a network resource, an access point device, an electronic device (for example, a mobile phone, a computing device such as a notebook computer, or both), or any combination thereof according to some example embodiments.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of an exemplary access point device, client device, and extender access point device implemented in the network environment of FIG. 1, according to one or more aspects of the present disclosure;

FIG. 3 is a more detailed block diagram illustrating certain components of an exemplary network device implemented in FIGS. 1-2, according to one or more aspects of the present disclosure;

FIG. 4 is a flow diagram illustrating monitoring one or more telemetry metrics associated with one or more network devices, according to one or more aspects of the present disclosure; and

FIG. 5 is a flow chart illustrating a method for monitoring one or more access point device for one or more telemetry metrics, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

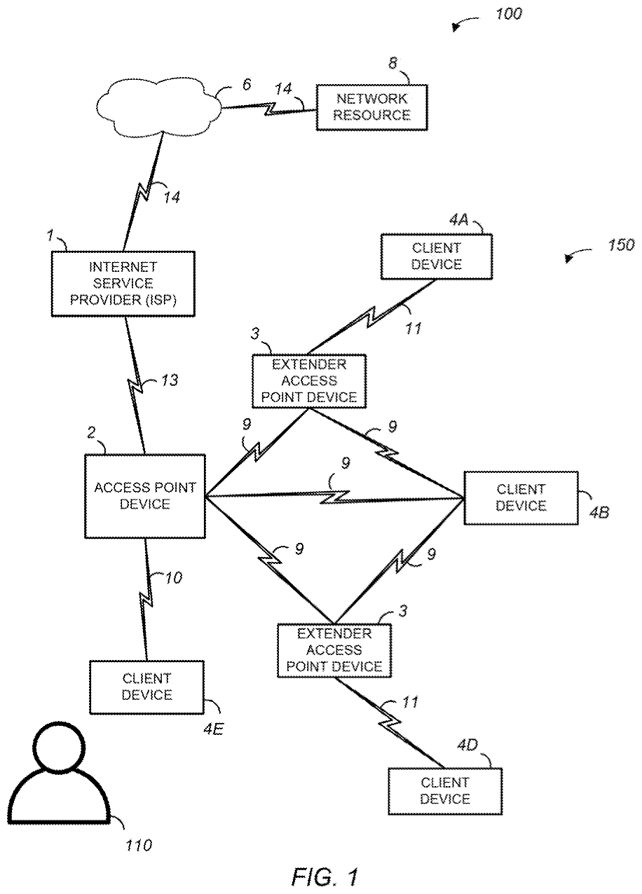

FIG. 1 is a schematic diagram of a network environment 100, according to one or more example embodiments. It should be appreciated that various example embodiments of inventive concepts disclosed herein are not limited to specific numbers or combinations of devices, and there may be one or multiple of some of the aforementioned electronic apparatuses in the system, which may itself consist of multiple communication networks and various known or future developed wireless connectivity technologies, protocols, devices, and the like.

The network environment 100 comprises a network resource 8 connected to Internet 6 and an access point device 2, for example, a main APD, connected to the Internet 6 via an Internet Service Provider (ISP) 1 and also connected to different network devices such as one or more wireless extender access point devices 3, for example, a satellite APD, and one or more client devices 4A-4E, collectively referred to as client device(s) 4. The network 150 shown in FIG. 1 includes network devices (for example, an access point device 2, an extender access point device 3 and a client device 4) that may be connected in one or more wireless networks (for example, private, guest, iControl, backhaul network, or Internet of things (IoT) network) within the network 150. Additionally, there could be some overlap between network devices (for example, extender access point devices 3 and client devices 4) in the different networks. That is, one or more network or wireless devices could be located in more than one network. For example, the extender access point devices 3 could be located both in a private network for providing content and information to a client device 4 and also included in a backhaul network or an iControl network.

The ISP 1 of network environment 100 can be for connecting the access point device 2 to the Internet 6. The network resource 8 can be any type of network device and/or network repository that monitors one or more telemetry metrics associated with one or more network devices of network 150 in network environment 100. The connection 14 between the Internet 6 and the ISP 1 and between the Internet 6 and network resource 8 and the connection 13 between the ISP 1 and the APD 2 can be implemented using a wide area network (WAN), a virtual private network (VPN), metropolitan area networks (MANs), system area networks (SANs), a data over cable service interface specification (DOCSIS) network, a fiber optics network (for example, FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, 6G, etc. network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the APD 2 and a WAN, a LAN, a VPN, MANs, PANs, WLANs, SANs, a DOCSIS network, a fiber optics network (for example, FTTH, FTTX, or HFC), a PSDN, a global Telex network, or a 2G, 3G, 4G, 5G, or 6G network, for example.

The APD 2 can be, for example, an access point and/or a hardware electronic device that may be a combination modem and gateway that combines the functions of a modem, an access point (AP), and/or a router for providing content received from the ISP 1 to network devices (for example, one or more wireless EAPDs 3 and one or more client devices 4) in the network 150. It is also contemplated by the present disclosure that the APD 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The APD 2 may also be referred to as a residential gateway, a home network gateway, or a wireless access point (AP). The APD 2 can receive one or more telemetry metrics from an EAPD 3 or determine one or more telemetry metrics associated with an EAPD 3 based on one or more packets (for example, traffic) from the EAPD 3.

The connection 9 between the access point device 2, the wireless extender access point devices 3, and client devices 4 can be implemented using a wireless connection in accordance with any IEEE 802.11 Wi-Fi protocols, Bluetooth protocols, Bluetooth low energy (BLE), or other short range protocols that operate in accordance with a wireless technology standard for exchanging data over short distances using any licensed or unlicensed band such as the citizens broadband radio service (CBRS) band, 2.4 GHz band, 5 GHz band, 6 GHz band, or 60 GHz band. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more connections 9 can carry one or more telemetry metrics or one or more packets associated with one or more telemetry metrics from an EAPD 3 to an APD 2 for delivery to a network resource 8.

The EAPDs 3 can be, for example, wireless hardware electronic devices such as access points, extenders, repeaters, etc. used to extend the wireless network by receiving the signals transmitted by the access point device 2 and rebroadcasting the signals to, for example, client devices 4, which may out of range of the access point device 2. The extender access point devices 3 can also receive signals from the client devices 4 and rebroadcast the signals to the access point device 2, or other client devices 4.

The connection 11 between the EAPDs 3 and the client devices 4 are implemented through a wireless connection that operates in accordance with any IEEE 802.11 Wi-Fi protocols, Bluetooth protocols, BLE, or other short range protocols that operate in accordance with a wireless technology standard for exchanging data over short distances using any licensed or unlicensed band such as the CBRS band, 2.4 GHz band, 5 GHz band, 6 GHz band, or 60 GHz band. Additionally, the connection 11 can be implemented using a wireless connection that operates in accordance with, but is not limited to, RF4CE protocol, ZigBee protocol, Z-Wave protocol, or IEEE 802.15.4 protocol. Also, one or more of the connections 11 can be a wired Ethernet connection. Any one or more connections 11 can carry one or more telemetry metrics or one or more packets associated with one or more telemetry metrics from a client device 4 to an EAPD 3.

The client devices 4 can be any type of network device that connects to an access APD 2, an EAPD 3, or both, for example, hand-held computing devices, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the access point device 2. Additionally, the client devices 4 can be a television (TV), an IP/QAM set-top box (STB) or a streaming media decoder (SMD) that is capable of decoding audio/video content, and playing over OTT or MSO provided content received through the access point device 2. For example, a client device 4E can be a mobile phone associated with a user 110 and capable of receiving one or more configuration notifications from the APD 2 regarding the configuration of the APD2. In one or more embodiments, the client device 4E can initiate a configuration or onboarding of the APD2.

The connection 10 between the access point device 2 and the client device 4 is implemented through a wireless connection that operates in accordance with, but is not limited to, any IEEE 802.11 protocols. Additionally, the connection 10 between the access point device 2 and the client device 4 can also be implemented through a WAN, a LAN, a VPN, MANs, PANs, WLANs, SANs, a DOCSIS network, a fiber optics network (for example, FTTH, FTTX, or HFC), a PSDN, a global Telex network, or a 2G, 3G, 4G, 5G, 6G, etc. network, for example. The connection 10 can also be implemented using a wireless connection in accordance with Bluetooth protocols, BLE, or other short range protocols that operate in accordance with a wireless technology standard for exchanging data over short distances using any licensed or unlicensed band such as the CBRS band, 2.4 GHz band, 5 GHz band, 6 GHz band, or 60 GHz band. One or more of the connections 10 can also be a wired Ethernet connection. Any one or more connections 10 can carry one or more telemetry metrics or one or more packets associated with one or more telemetry metrics from a client device 4 to an APD 2.

The present disclosure contemplates that the network resource 8, the APD 2, the one or more EAPDs 3, and the one or more client devices 4 include electronic components or electronic computing devices operable to any of receive, transmit, process, store, monitor, analyze information, or any combination thereof (for example, one or more telemetry metrics associated with the network 150 and/or network environment 100), and encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the network resource 8, the APD 2, the one or more EAPDs 3, and the one or more client devices 4 may be adapted to execute any operating system, including Linux, UNIX, Windows, MacOS, DOS, and Chrome OS as well as virtual machines adapted to virtualize execution of a particular operating system, including customized and proprietary operating systems. The network resource, the APD 2, the one or more EAPDs 3, and the one or more client devices 4 are further equipped with components to facilitate communication with other network devices over the one or more network connections to local and wide area networks, wireless and wired networks, public and private networks, and any other communication network enabling communication in the network 150 and/or network environment 100.

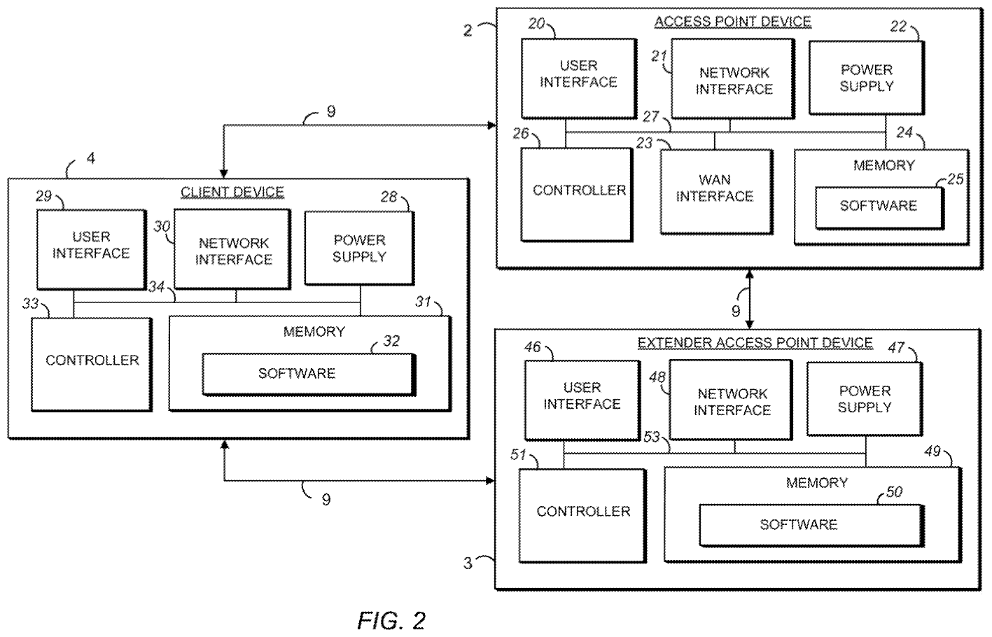

FIG. 2 is a more detailed block diagram illustrating various components of an exemplary APD 2, a client device 4, and a EAPD 3 implemented in the network 150 of FIG. 1, according to some example embodiments.

Although FIG. 2 only shows one EAPD 3 and one client device 4, the EAPD 3 and the client device 4 shown in the figure are meant to be representative of the other EAPDs 3 and client devices 4 of a network system, for example, system 100 shown in FIG. 1. Similarly, the connections 9 between the APD 2, the EAPD 3, and the client device 4 shown in FIG. 2 are meant to be exemplary connections and are not meant to indicate all possible connections between the APDs 2, EAPDs 3, and client devices 4. Additionally, it is contemplated by the present disclosure that the number of APDs 2, EAPDs 3, and client devices 4 is not limited to the number of APDs 2, EAPDs 3, and client devices 4 shown in FIGS. 1 and 2.

Now referring to FIG. 2, the client device 4 can be, for example, a computer, a portable device, an electronic tablet, an e-reader, a PDA, a mobile phone such as a smart phone, a smart speaker, an IoT device, an iControl device, portable music player with smart capabilities capable of connecting to the Internet, cellular networks, and interconnecting with other devices via Wi-Fi and Bluetooth, or other wireless hand-held consumer electronic device capable of receiving one or more configuration notifications from APD 2.

As shown in FIG. 2, the client device 4 includes a power supply 28, a user interface 29, a network interface 30, a memory 31, and a controller 33. The power supply 28 supplies power to the internal components of the client device 4 through the internal bus 34. The power supply 28 can be a self-contained power source such as a battery pack with an interface to be powered through an electrical charger connected to an outlet (for example, either directly or by way of another network device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 29 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user and the client device 4. The network interface 30 can include, but is not limited to, various network cards, interfaces, and circuitry implemented in software and/or hardware to enable communications with the access point device 2 and the extender access point device 3 using the communication protocols in accordance with connection 9 (for example, as described with reference to FIG. 1).

The memory 31 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 31 can be used to store any type of instructions, software, or algorithms including software 32 for controlling the general function and operations of the client device 4 in accordance with the embodiments described in the present disclosure. In one or more embodiments, client device 4 is an electronic device, such as a mobile phone, and software 32 includes one or more instructions for establishing a FH connection with the access point device 2.

The controller 33 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the client device 4 in accordance with the embodiments described in the present disclosure. Communication between the components (for example, 28-31 and 33) of the client device 4 may be established using an internal bus 34.

The EAPD 3 can be, for example, any wireless hardware electronic device used to extend a wireless network by receiving the signals transmitted by the APD 2 and rebroadcasting the signals to a client device 4, which may be out of range of the APD 2 including, but not limited to, a wireless extender, a repeater, and/or an access point. The EAPD 3 can also receive signals from any one or more of the client devices 4 and rebroadcast the signals to the APD 2, or any other one or more client devices 4.

As shown in FIG. 2, the EAPD 3 includes a user interface 46, a power supply 47, a network interface 48, a memory 49, and a controller 51. The user interface 46 can include, but is not limited to, push buttons, a keyboard, a keypad, an LCD, a TFT, an LED, an HD or other similar display device including a display device having touch screen capabilities so as to allow interaction between a user and the EAPD 3. The power supply 47 supplies power to the internal components of the EAPD 3 through the internal bus 53. The power supply 47 can be connected to an electrical outlet (for example, either directly or indirectly by way of another device) via a cable or wire.

The network interface 48 can include various network cards, interfaces, and circuitry implemented in software and/or hardware to enable communications with the client device 4 and the APD 2 using the communication protocols in accordance with connection 9 (for example, as described with reference to FIG. 1). For example, the network interface 48 can include multiple radios or sets of radios (for example, a 2.4 GHz radio, one or more 5 GHz radios, and/or a 6 GHz radio), which may also be referred to as wireless local area network (WLAN) interfaces. One radio or set of radios (for example, 5 GHz and/or 6 GHz radio(s)) provides a BH connection between the EAPD 3 and the APD 2, and optionally other EAPD(s) 3. Another radio or set of radios (for example, 2.4 GHz, 5 GHz, and/or 6 GHz radio(s)) provides a fronthaul (FH) connection between the EAPD 3 and one or more client device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the EAPD 3 in accordance with the embodiments described in the present disclosure. The memory 49 can also store or more telemetry metrics associated with an EAPD 3.

The controller 51 controls the general operations of the EAPD 3 and can include, but is not limited to, a CPU, a hardware microprocessor, a hardware processor, a multi-core processor, a single core processor, an FPGA, a microcontroller, an ASIC, a DSP, or other similar processing device capable of executing any type of instructions, algorithms, or software for controlling the operation and functions of the EAPD 3 in accordance with the embodiments described in the present disclosure. General communication between the components (for example, 46-49 and 51) of the EAPD 3 may be established using the internal bus 53.

The APD 2 can be, for example, a hardware electronic device that can combine one or more functions of any of a modem, a gateway, an access point (AP), a router, or combinations thereof for providing content received from the content provider (ISP) 1 to network or wireless devices (for example, extender access point devices 3, client devices 4) in the network 150. It is also contemplated by the present disclosure that the APD 2 can include the function of, but is not limited to, an IP/QAM STB or SMD that is capable of decoding audio/video content, and playing OTT or MSO provided content. As shown in FIG. 2, the APD 2 includes a user interface 20, a network interface 21, a power supply 22, a wide area network (WAN) interface 23, a memory 24, and a controller 26. The user interface 20 can include, but is not limited to, push buttons, a keyboard, a keypad, an LCD, a TFT, an LED, an HD or other similar display device including a display device having touch screen capabilities so as to allow interaction between a user and the access point device 2, for example, so as to provide one or more configuration notifications to a user.

The network interface 21 may include various network cards, and circuitry implemented in software and/or hardware to enable communications with the extender access point device 3 and the client device 4 using the communication protocols in accordance with connection 9 (for example, as described with reference to FIG. 1). Additionally, the various network cards, interfaces, and circuitry of the network interface 21 enable communications with a client device 4 (for example, a mobile device) using the one or more communication protocols in accordance with connection 10 (for example, as described with reference to FIG. 1). For example, the network interface 21 can include an Ethernet port (also referred to as a LAN interface) and multiple radios or sets of radios (for example, a 2.4 GHz radio, one or more 5 GHz radios, a 6 GHz radio, and/or any other radio also referred to as WLAN interfaces). One radio (and/or set of radios) (for example, 5 GHz and/or 6 GHz radio(s)) provides a BH connection between the APD 2 and the EAPD(s) 3. Another radio (and/or set of radios) (for example, 2.4 GHz, 5 GHz, 6 GHz, and/or other radio(s)) provides a FH connection between the APD 2 and one or more client device(s) 4.

The power supply 22 supplies power to the internal components of the APD 2 through the internal bus 27. The power supply 22 can be connected to an electrical outlet (for example, either directly or by way of another device) via a cable or wire. The wide area network (WAN) interface 23 may include various network cards, and circuitry implemented in software and/or hardware to enable communications between the APD 2 and the ISP 1 using the wired and/or wireless protocols in accordance with connection 13 (for example, as described with reference to FIG. 1).

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be a non-transitory computer-readable storage medium used to store any type of instructions, software, or algorithm including software 25 for controlling the general functions and operations of the 2. In one or more embodiments, the memory 24 can store software for receive one or more telemetric metrics associated with an APD 2, an EAPD 2, or both. The memory 24 can also store or more telemetry metrics associated with the APD 2, the EAPD 3, or both.

The controller 26 controls the general operations of the APD 2 as well as performs configuration and connection functions related to one or more network devices (network resource 8, one or more EAPDs 3 and client device 4) in the network. The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of computer-readable instructions, algorithms, or software including the software 25 for controlling the operation and functions of the APD 2 in accordance with the embodiments described in the present disclosure. Communication between the components (for example, 20-24, and 26) of the APD 2 may be established using the internal bus 27. The controller 26 may also be referred to as a processor, generally.

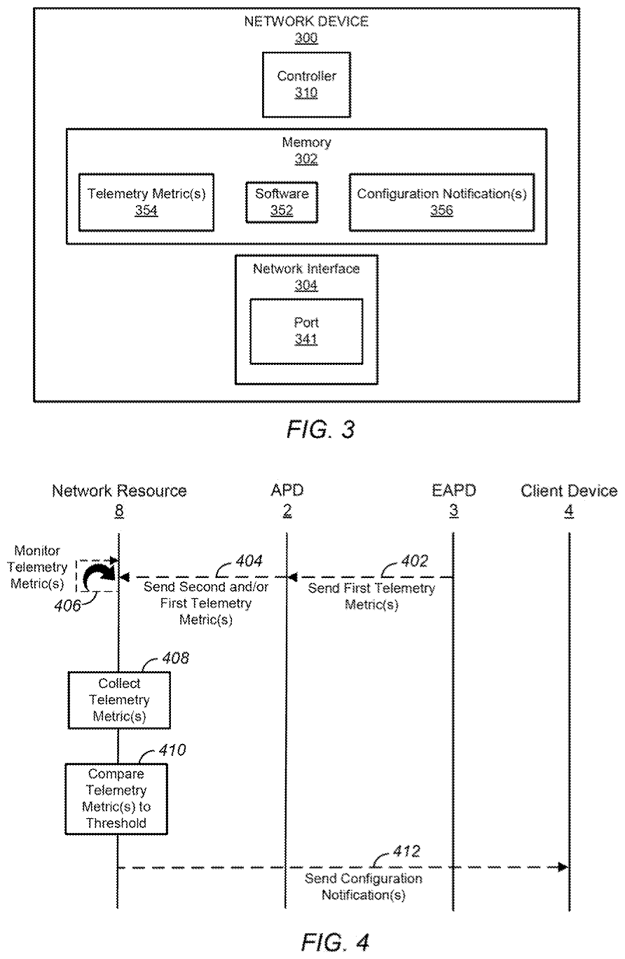

FIG. 3 is a more detailed block diagram illustrating certain components of an exemplary network device 300, for example, a network resource 8, any other network device capable of monitoring telemetry metrics, or any combination thereof according to one or more aspects of the present disclosure.

As shown in FIG. 3, the network device 300 includes the network interface 304, for example, similar to or the same as, for example, network interface 21, etc. of FIG. 2, the memory 302, for example, similar to or the same as, for example, network memory 24, etc. of FIG. 2, and the controller (processor) 310, for example, similar to or the same as, for example, controller 26, etc. of FIG. 2. The network interface 304 includes a port 341 (for example, a wired LAN interface or any other interface). The network device 300 may communicate with any one or more of the local area network devices (for example, any of an APD 2, the one or more EAPDs 3, the one or more client devices 4, or any combination thereof) of a network environment 100, for example, network 150 of FIG. 1, via the network interface 304.

The memory 302 stores one or more computer-readable instructions, for example, any of a software or application 352, one or more telemetry metrics 354, one or more configuration notifications 356, or any combination thereof. The one or more telemetry metrics 354 can comprise any of RSSI, memory, channel utilization, receive (Rx)/transmit (Tx) rate, CPU utilization, temperature, any other telemetry data, or any combination thereof. Any of the one or more configuration notifications 356 can be associated with one or more network issues, for example, an installation issue, a usage issue, or both. The one or more configuration notifications 356 can provide information for remediating a network issue. For example, a first configuration notification 356 can be associated with an installation issue (for example, based on one or more RSSI telemetry metrics and/or an RSSI threshold) and can indicate to a user to change a location of a network device (such as to re-locate an APD 2, an EAPD 3, or both) and a second configuration notification 356 can be associated with a usage issue (for example, based on a channel utilization telemetry metric or channel utilization threshold) and can indicate or provide an instruction to a user to perform one or more remedial actions such as any of reduce a number of service set identifiers (SSIDs), reduce a channel width (for example, from 40 Megahertz (MHz) to 20 MHz), remove low bit rate support, allow distributed file system (DFS) if not enabled, reboot device (for example, so as to cause the device to select a different channel), or any combination thereof.

The controller 310 can include or be a processor that is configured to access the memory 302. The controller 310 also controls communications with the network or wireless devices via the port 341 in accordance with embodiments described in the present disclosure. The controller 310 can execute a software 352 that comprises one or more computer-readable instructions for monitoring for one or more telemetry metrics 354 associated with one or more network devices (such as any of a main APD), an EAPD 3 (such as a satellite APD), or both). The controller 310 can further execute the software 352 to analyze the one or more telemetry metrics 354 to determine one or more configuration notifications 356 associated with one or more network issues indicated by any of the one or more telemetry metrics 354, select at least one of the configuration notifications 356 based on the determination, and send or transmit the at least one of the configuration notifications 356 to a user, for example, a network device associated with the user, such as a client device 4.

FIG. 4 is a flow diagram illustrating monitoring one or more telemetry metrics associated with one or more network devices, such as a main APD (for example, an APD 2) and one or more satellite APDs (for example, one or more EAPDs 3), according to one or more aspects of the present disclosure, according to one or more embodiments.

The network device, for example, a network resource 8, may be programmed with one or more instructions (for example, one or more computer-readable instructions) to perform the monitoring of one or more telemetry metrics according to one or more embodiments. In FIG. 4, it is assumed that any one or more network devices include their respective controllers and their respective software stored in their respective memories, as discussed above in connection with FIGS. 1-3, which when executed by their respective controllers perform the functions and operations in accordance with the example embodiments of the present disclosure.

A network device can comprise a controller 310 that executes one or more computer-readable instructions, stored on a memory 302, that when executed perform one or more of the operations according to one or more aspects of the present disclosure. In one or more embodiments, the one or more instructions can be one or more software applications, for example, one or more software 25. While the operations are presented in a certain order, the present disclosure contemplates that any one or more operations can be performed simultaneously, substantially simultaneously, repeatedly, in any order or not at all (omitted).

In one or more embodiments, a network resource 8 can be a cloud resource located remote from the network 150. The network resource 8 can communicate with an APD 2 so as to receive one or more telemetry metrics associated with one or more network devices in a network 150 indirectly via an ISP 1 or directly via some other connection. At 402 an EAPD 3, for example a satellite APD, can send one or more first telemetry metrics 402 associated with the EAPD 3 to the APD 2. The one or more first telemetry metrics 402 can indicate a network issue associated with the EAPD 3, for example, an installation issue, a usage issue, or both. At 404, the APD 2, can send one or more second telemetry metrics, the one or more first telemetry metrics from 402, or both to the network resource 8. The one or more second telemetry metrics can indicate a network issue associated with the APD 2, for example, an installation issue, a usage issue, or both.

At 406, the network resource can monitor for one or more telemetry metrics associated with one or more network devices in a network 150. For example, the network resource 8 can receive one or more telemetry metrics from the APD 2, such as the one or more second telemetry metrics, the one or more first telemetry metrics, or both. The monitoring for the one or more telemetry metrics can comprise any of selecting a network issue for monitoring (such as an installation issue, a usage issue, or both), receiving (such as any of periodically, at timed intervals, upon request by a user, such as on-demand by an administrator, continuously, any other time period, or any combination thereof) the one or more telemetry metrics, querying the APD 2 for the one or more telemetry metrics, or any combination thereof.

At 408, the network resource 8 can collect the one or more telemetry metrics. For example, the network resource 8 can monitor traffic from the APD 2 at 406 and at 408 can store any one or more telemetry metrics received from the APD in the monitored traffic. The one or more telemetry metrics can be stored in a repository, such as a database, local to or remote from the network resource 8. The collecting the one or more telemetry metrics can comprise organizing or otherwise tagging the one or more telemetry metrics based on any of a network device associated with each of the one or more telemetry metrics, a network issue indicated by each of the one or more telemetry metrics, or both and storing the tagged one or more telemetry metrics.

At 410, the network resource 8 can compare one or more telemetry metrics associated with a network issues to a threshold, for example, based on the one or more network issues selected for monitoring at 406. For example, the network resource 8 can determine an average of the one or more telemetry metrics associated with a network issue, for example, each selected or predetermined network issue. The network resource 8 can compare the determined average associated with the network issue or each selected network issue to an associated threshold. As an example, the selected network issue can comprise an installation issue. The network resource 8 can average the one or more telemetry metrics that comprise one or more RSSIs associated with a network device, for example, as collected at 408, and compare this RSSI average to an RSSI threshold. Similarly, the selected network issue can comprise a channel utilization issue. The network resource 8 can average the one or more telemetry metrics that comprise one or more channel utilizations associated with a network device, for example, as collected at 408, and compare this channel utilization average to a channel utilization threshold. In one or more embodiments, a threshold is a distinct value or a range of values.

At 412, the network resource 8 can determine a configuration notification associated with the network issue based on the comparison at 410 and send the configuration notification to a user, for example, a user associated with a client device 4. For example, the network resource 8 can determine that the comparison of 410 indicates that the selected network issue exists and thus an associated configuration notification should be sent. The one or more configuration notifications can comprise one or more remedial actions, for example, one or more instructions for the user to perform a remedial action to address a network issue.

As an example, the selected network issue can be an installation issue such that at 410 the network resource 408 averages all RSSIs of all client devices on a radio of a network device based on the one or more telemetry metrics received or collected as an RSSI average. The network resource can compare the RSSI average to an installation threshold, such as an RSSI threshold. For example, the average RSSI can be determined as −85 decibel milliwatts (dBm) and the RSSI threshold can be set to −65 dBm and thus the comparison indicates that the average RSSI does not meet the RSSI threshold requirement indicating that the network device is not within reach of one or more client devices. The network resource 408 can then send a configuration notification to the user that instructs the user to change locations, such as to re-install the network device.

As another example, the selected network issue can be a usage issue such that at 410 the network resource 408 averages all channel utilizations of a radio on a network device over time. The network resource can compare the channel utilization average to usage threshold, such as an installation threshold, such as an RSSI threshold. For example, the average channel utilization can be determined as 80% utilization and the channel utilization threshold set to 60% utilization (such as 60% channel utilization across one or more hours) and thus the comparison indicates that the average channel utilization does not meet the channel utilization threshold requirement indicating too much activity, interference or both on the channel. The network resource 408 can then send a configuration notification to the user that instructs the user to reduce a number of service set identifiers (SSIDs), reduce a channel width, remove low bit rate support, allow DFS if not enabled, reboot the network device, or any combination thereof.

After one or more remedial actions have been performed as identified in the one or more configuration notifications sent at 412, the process can continue at 406 so as to periodically or continuously monitor for one or more telemetry metrics associated with a network device for a selected or predetermined network issue. For example, the network resource 8 can receive an indication from a user based on the one or more configurations, for example, if the network issue comprises an installation issue, that the network device has been re-installed or that the location has changed, if the network issue comprises a usage issue, that one or more remediations or one or more remedial actions as indicated by the one or more configuration notifications has been performed or attempted, or both. The network resource 8, can query the network device based on the indication from the user. For example, the indication received from a client device 4 associated with the user can trigger the process to return to 406 where the monitoring for one or more telemetry metrics associated with the network device, such as APD 2, comprises querying the network device (for example, APD 2) for one or more telemetry metrics associated with the network issue.

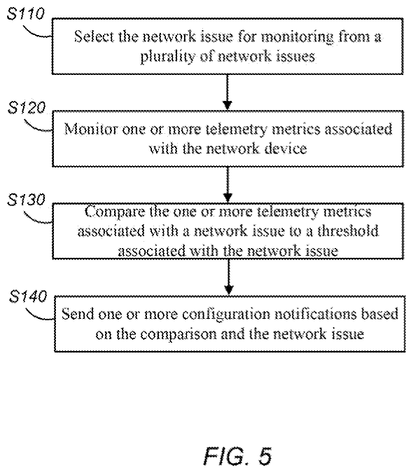

In one or more embodiments, a network resource 8 may include a controller 310 that may be programmed with or to execute one or more instructions (for example, software or application 352) to perform steps for monitoring one or more telemetry metrics associated with one or more network devices for one or more selected network issues, such as an APD 2, including, but not limited to, a main APD 2, a satellite APD2 (for example, an EAPD 3), or both, in a network, such as network 150. In FIG. 5, it is assumed that the network devices include their respective controllers and their respective software stored in their respective memories, as discussed above in reference to FIGS. 1-4, which when executed by their respective controllers perform the functions and operations in accordance with the example embodiments of the present disclosure.

The controller 310 executes one or more computer-readable instructions, stored in a memory, for example, a memory a memory 302 of a network resource 8 that when executed perform one or more of the operations of steps S110-S140. In one or more embodiments, the one or more instructions may be one or more software applications, for example, a software 352 of a network resource 8. While the steps S110-S140 are presented in a certain order, the present disclosure contemplates that any one or more steps can be performed simultaneously, substantially simultaneously, repeatedly, in any order or not at all (omitted).

At step S110, the network resource can select a network issue for monitoring. For example, a network issue can comprise any of an installation issue, a usage issue, any other issue, or any combination thereof. The selected network issue can be received from a user via a user interface that prompts the user for a network issue to monitor. In one or more embodiments, a network issue can be selected based, for example, on a parameter stored in a memory, received based on a query to a repository, or both.

At step S120, the network resource can monitor one or more telemetry metrics associated with a network device. If a network issue is selected in step S110, the monitoring one or more telemetry metrics can be based on the selected network issue. The monitoring can comprise any of selecting a network issue for monitoring (from step S110), receiving the one or more telemetry metrics, querying the APD 2 for the one or more telemetry metrics, or any combination thereof. In one or more embodiments, the one or more telemetry metrics comprise one or more received signal strength indicators (RSSIs) associated with an installation issue of the one or more network issues, one or more channel utilizations associated with a usage issue of the one or more network issues, or both.

At step S130, the network resource can compare the one or more telemetry metrics associated with the network issue to a threshold associated with the network issue. The threshold can be set by a user via a user interface of the network resource. In one or more embodiments, the threshold comprises an installation threshold associated with an installation issue of the one or more network issues, and a usage threshold associated with a usage issue of the one or more network issues. In one or more embodiments, comparing the one or more telemetry metrics to a corresponding threshold comprises averaging the one or more RSSIs associated with the network device and comparing the averaged RSSIs to the installation threshold, averaging the one or more channel utilizations associated with the network device and comparing the averaged channel utilization to the usage threshold, or both.

At step S140, the network resource can send one or more configuration notifications based on the comparison from step S130 and the network issue. The one or more configuration notifications can comprise one or more remedial actions. For example, the one or more remedial actions can be directed to a user via a user interface of the network resource to remediate a network issue.

While FIGS. 4 and 5 are directed to a network resource 8 performing the one or more steps or operations, the present disclosure contemplates that any network device capable of monitoring for one or more telemetry metrics associated with any or a selected network device for a selected network issue so as to provide one or more configuration notifications to a user, for example, via a client device 4. The network resource, for example, can be included within or as part of the APD 2 or local to a network that comprises the APD 2.

According to one or more example embodiments of inventive concepts disclosed herein, there are provided novel solutions for establishing a BH connection between an access point device and an extender access point device. The novel solutions according to example embodiments of inventive concepts disclosed herein provide features that enhance, for example, configuration of home/residential network gateway (GW) devices, wireless access points (Wi-Fi APs), Home Network Controller (HNC) devices, wireless routers, mesh networking nodes (for example, Wi-Fi EasyMesh systems), and the like. By automatically selecting an initial BH channel, configuration or initialization of the access point device can continue without the delay due to the access point device waiting on the selection of the best channel and/or best radio for establishing the BH connection. The user is notified regarding the initialization or configuration and the selection of the BH channel. In this way, the user does not experience a delay in operation of the access point device or is provided with information so as to understand the delay in operation.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A network resource for monitoring one or more telemetry parameters associated with a network device, the network resource comprising:
a memory storing one or more computer-readable instructions;
a processor configured to execute the one or more computer-readable instructions stored on the memory to cause the network resource to:
monitor one or more telemetry metrics associated with the network device;
compare the one or more telemetry metrics associated with a network issue to a threshold associated with the network issue; and
send one or more configuration notifications based on the comparison and the network issue.

2. The network resource of claim 1, wherein the monitoring comprises receiving the one or more telemetry metrics from the network device.

3. The network resource of claim 1, wherein the processor is further configured to execute the one or more computer-readable instructions to cause the network resource to:
select the network issue for monitoring from a plurality of network issues.

4. The network resource of claim 1, wherein the network issue comprises an installation issue, a usage issue, or both, and wherein the threshold comprises an installation threshold associated with the installation issue, and a usage threshold associated with the usage issue.

5. The network resource of claim 4, wherein the one or more telemetry metrics comprise one or more received signal strength indicators (RSSIs) associated with the installation issue, one or more channel utilizations associated with the usage issue, or both.

6. The network resource controller of claim 5, wherein comparing the one or more telemetry metrics to the threshold comprises:
averaging the one or more RSSIs associated with the network device and comparing the averaged RSSIs to the installation threshold; and
averaging the one or more channel utilizations associated with the network device and comparing the averaged channel utilization to the usage threshold.

7. The network resource of claim 1, wherein the one or more configuration notifications comprise one or more remedial actions.

8. A method for a network resource for monitoring one or more telemetry parameters associated with a network device, the method comprising:
monitoring one or more telemetry metrics associated with the network device;
comparing the one or more telemetry metrics associated with a network issue to a threshold associated with the network issue; and
sending one or more configuration notifications based on the comparison and the network issue.

9. The method of claim 8, wherein the monitoring comprises receiving the one or more telemetry metrics from the network device.

10. The method of claim 8, further comprising:
selecting the network issue for monitoring from a plurality of network issues.

11. The method of claim 8, wherein the network issue comprises an installation issue, a usage issue, or both, and wherein the threshold comprises an installation threshold associated with the installation issue, and a usage threshold associated with the usage issue.

12. The method of claim 11, wherein the one or more telemetry metrics comprise one or more received signal strength indicators (RSSIs) associated with the installation issue, one or more channel utilizations associated with the usage issue, or both.

13. The method of claim 12, wherein comparing the one or more telemetry metrics to the threshold comprises:
averaging the one or more RSSIs associated with the network device and comparing the averaged RSSIs to the installation threshold; and
averaging the one or more channel utilizations associated with the network device and comparing the averaged channel utilization to the usage threshold.

14. The method of claim 8, wherein the one or more configuration notifications comprise one or more remedial actions.

15. A non-transitory, computer-readable medium storing one or more computer-readable instructions for a network resource for monitoring one or more telemetry parameters associated with a network device, that when executed by a processor, cause the processor to perform one or more operations comprising:
monitoring one or more telemetry metrics associated with the network device;
comparing the one or more telemetry metrics associated with a network issue to a threshold associated with the network issue; and
sending one or more configuration notifications based on the comparison and the network issue.

16. The non-transitory, computer-readable medium of claim 15, wherein the monitoring comprises receiving the one or more telemetry metrics from the network device.

17. The non-transitory, computer-readable medium of claim 15, wherein the one or more computer-readable instructions when executed by the processor, further cause the processor to perform the one or more operations further comprising:
selecting the network issue for monitoring from a plurality of network issues.

18. The non-transitory, computer-readable medium of claim 15, wherein at least one of:
the network issue comprises an installation issue, a usage issue, or both, and wherein the threshold comprises an installation threshold associated with the installation issue, and a usage threshold associated with the usage issue; and
the one or more telemetry metrics comprise one or more received signal strength indicators (RSSIs) associated with the installation issue, one or more channel utilizations associated with the usage issue, or both.

19. The non-transitory, computer-readable medium of claim 18, wherein comparing the one or more telemetry metrics to the threshold comprises:
averaging the one or more RSSIs associated with the network device and comparing the averaged RSSIs to the installation threshold; and
averaging the one or more channel utilizations associated with the network device and comparing the averaged channel utilization to the usage threshold.

20. The non-transitory, computer-readable medium of claim 15, wherein the one or more configuration notifications comprise one or more remedial actions.
